(19) United States
(12) Patent Application Publication
(10) Pub. No.: US 2007/0250534 A1
(43) Pub. Date: Oct. 25, 2007

(54) Virtual jukebox music system and method

(75) Inventor: Christopher Heikkila, Howell, MI (US)

Correspondence Address: HARNESS, DICKEY & PIERCE, P.L.C., P.O. BOX 828, BLOOMFIELD HILLS, MI, 48303, US

(73) Assignee: SeaHike, L.L.C., Hazel Park, MI (US)

(21) Appl. No.: 11/400,814

(22) Filed: Apr. 7, 2006

(51) Int. Cl. G06F 17/00; G06F 7/00

(52) U.S. Cl. 707/104.1

(57) ABSTRACT

A virtual jukebox music system includes a music database stored in a removable hard drive, a music creator module, a music player module, and a music selector module. The music creator module is connected to a CD drive, an input module, and a first computer readable medium for storing a music data management algorithm executable by said music creator module. The music player module plays music files in a music queue. The music selector module is connected to a touch screen input/output module, the music player module, the music queue, and a second computer readable medium for storing a music selection algorithm executable by the music selector module. The music database is selectively connectable to the music selector module and the music creator module. The music data management algorithm includes instructions for the music creator module to retrieve music files from the CD drive, convert the music files to a predetermined music database format, and store the music files in the music database. The music selection algorithm includes instructions for the music selector module to selectively retrieve the music files from the music database and place the music files in the music queue in response to input received from the touch screen input/output module.

### FIELD

The present disclosure relates to music playback systems, and more particularly to virtual jukebox music systems.

### BACKGROUND

The statements in this section merely provide background information related to the present disclosure and may not constitute prior art.

The traditional music jukebox with actual albums or compact discs were previously the focal point of restaurants, bars, home recreation rooms, and other gathering places. Music fans would often gather around the music jukebox and engage in the ritual of flipping through the displayed albums or CD covers, via mechanical levers, in search of the perfect song to suit the mood and setting.

Music jukeboxes containing the actual physical albums or compact discs are difficult, however, to maintain with up to date music given the amount, and production rate, of new popular music. Music fans expect a large selection of varied music choices. The availability of digital music files online compounds the problem. Satellite music services are available to provide music fans up to date music. Satellite music service players, however, lack the physical gathering point of the music jukebox. Traditional digital music players, such as mp3 players, and the like, are capable of storing a large amount of digital music. Digital music players, however, lack the focal-point appeal of a music jukebox. Thus, music fans do not gather around the traditional mp3 player to engage in the ritual of selecting music.

### SUMMARY

A virtual music jukebox system includes a music database stored in a removable hard drive. A music creator module is connected to a CD drive, an input module, and a computer readable medium for storing a music data management algorithm executable by the music creator module. A music player module plays music files in a music queue. A music selector module is connected to a touch screen I/O module, the music player module, the music queue, and another computer readable medium for storing at least one music selection algorithm executable by the music selector module. The music database is selectively connectable to the music selector module and the music creator module.

The music data management algorithm includes instructions for the music creator module to retrieve music files from the CD drive, convert the music files to a predetermined music database format, and store the music files in the music database. The music selection algorithm includes instructions for the music selector module to selectively retrieve the music files from the music database and place the music files in the music queue in response to the input received from the touch screen I/O module.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustration of an exemplary virtual jukebox music system;

FIG. 2 is a schematic illustration of an exemplary virtual jukebox music system;

FIG. 3 is a schematic illustration of an exemplary virtual jukebox music system;

FIG. 4 is a diagram of an exemplary data structure of an exemplary music database;

FIG. 5 is a flowchart illustrating a music data management algorithm;

FIG. 6 is a flowchart illustrating a music data modification algorithm;

FIG. 7 is a flowchart illustrating a music data creation algorithm;

FIG. 8 is a screenshot of music data management options;

FIG. 9 is a flowchart illustrating a music selection algorithm;

FIG. 10 is a flowchart illustrating a music selection by cover algorithm;

FIG. 11 is a flowchart illustrating a music selection by category algorithm;

FIG. 12 is a flowchart illustrating a music selection by artist algorithm;

FIG. 13 is a flowchart illustrating a music selection by song title algorithm;

FIG. 14 is a flowchart illustrating a music playlist display algorithm;

FIG. 15 is a flowchart illustrating an internet music selection algorithm;

FIG. 16 is a flowchart illustrating a music player algorithm;

FIG. 17 is a screenshot of music selection options;

FIG. 18 is a screenshot of music selection by cover options;

FIG. 19 is a screenshot of CD song selection options;

FIG. 20 is a screenshot of music selection by category options;

FIG. 21 is a screenshot of music selection by artist options; and

FIG. 22 is a screenshot of music selection by song options;

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, the term module refer to an application specific integrated circuit (ASIC), an electronic circuit, a processor (shared, dedicated, or group) and memory that execute one or more software or firmware programs, a combinational logic circuit, and/or other suitable components that provide the described functionality. Further, as used herein, computer-readable medium refers to any medium capable of storing data for a computer. Computer-readable medium may include, but is not limited to, CD-ROM, floppy disk, magnetic tape, other magnetic or optical medium capable of storing data, memory, RAM, ROM, PROM, EPROM, EEPROM, flash memory, or any other medium capable of storing data for a computer.

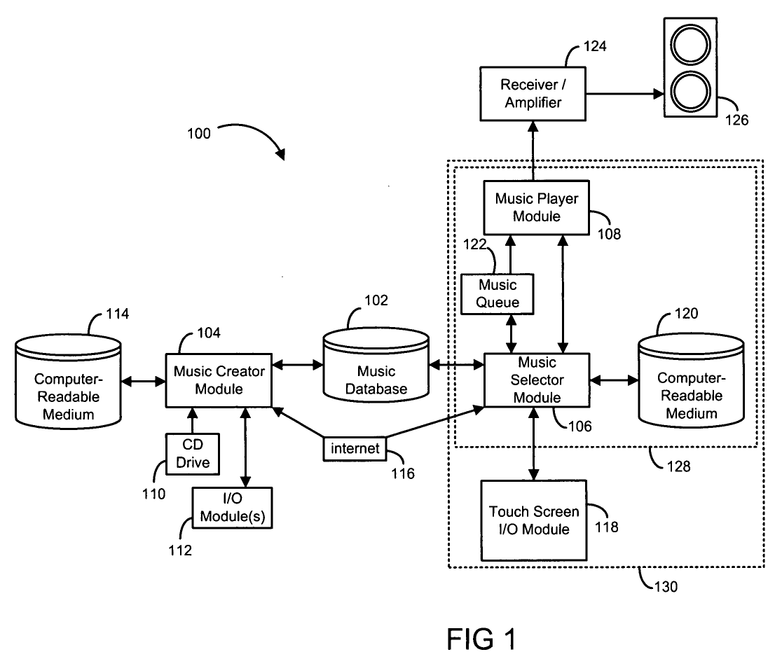

With reference to FIG. 1, a virtual jukebox music system 100 includes a music database 102, a music creator module 104, a music selector module 106, and a music player module 108. Digital audio files are created by the music creator module 104 from CDs in a connected CD drive 110 and stored in the music database 102. The music creator module 104 converts audio files from the CDs into a predetermined digital audio format, such as mp3, and stores the converted audio files in the music database 102. The music creator module 104 is operable by a user via the connected input/output module(s) 112, such as a mouse, keyboard, monitor, or other suitable input/output devices. The algorithms executed by the music creator module 104 are stored in a computer-readable medium 114 accessible to the music creator module 104.

The music creator module 104 is connected to the internet 116 via a dial-up, DSL, cable, or other suitable TCP/IP network connection. The music creator module 104 receives digital audio files from the internet 116. The received digital audio files are converted to the predetermined digital audio format and stored in the music database 102. Additionally, the music creator module 104 may receive digital audio files from other sources, such as a portable computer readable medium. For example, the music creator module 104 may receive digital audio files from a connected USB memory device.

The music creator module 104 is preferably implemented in software executed by a personal computer or other suitable computing device. The music database 102 is preferably contained in a removable hard drive that may be selectively connected to the music creator module 104 and the music selector module 106. The removable hard drive is preferably accessible via a USB connection.

The music selector module 106 accesses the digital audio files in the predetermined format stored in the music database 102 and selects music from the music database 102 based on user input. The music selector module 106 is operable by a user via a touch screen input/output module 118, or touch screen I/O module 118. Music selection algorithms executed by the music selector module 106 are stored in a computer-readable medium device 120.

The music selector module 106 is also connected to the internet 116 via a dial-up, DSL, cable, or other suitable TCP/IP network connection. The music selector module 106 may receive digital audio files from the internet 116. The music selector module 106 may also receive streamed digital audio files from the internet 116 via an internet radio broadcast.

Based on input received via the touch screen I/O Module 118, the music selector module 106 places digital audio files from the music database 102 into a music queue 122. The music selector module 106 also places digital audio files received form the internet 116 from an internet music website or from an internet radio broadcast.

The music player module 108 is connected to speakers 126 through a receiver/amplifier 124 and sequentially plays the digital audio files in the music queue 122. The music selector module 106, music player module 108, and music queue 122 are preferably implemented in software. The music selector module 106, music player module 108, music queue 122, computer-readable medium 120, together with the touch screen I/O module 118, may comprise an integrated jukebox with touch screen unit 130. Alternatively, the music selector module 106, music player module 108, music queue 122, and computer-readable medium 120 may comprise an integrated jukebox unit 128 separate from the touch screen I/O module 118.

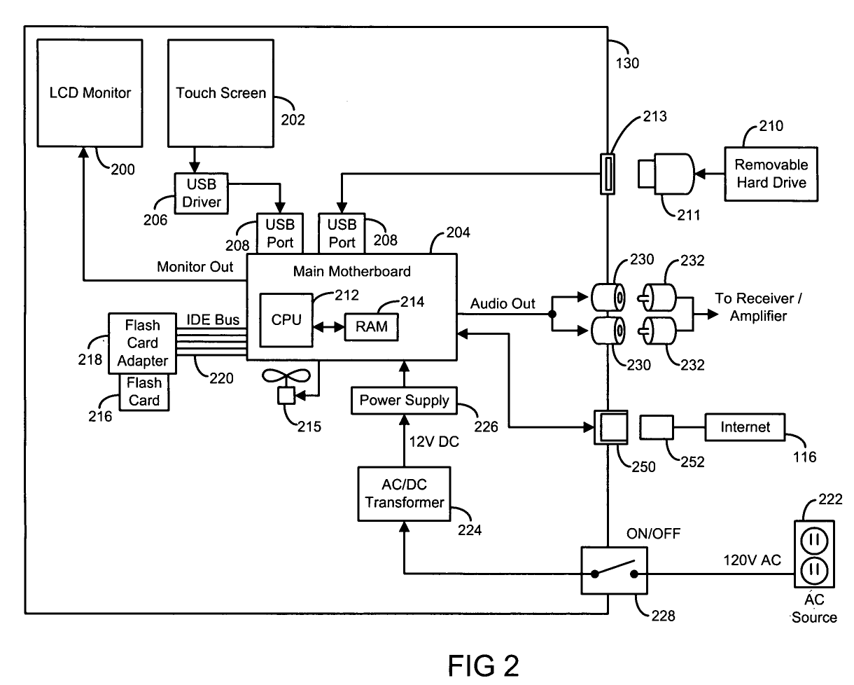

With reference to FIG. 2, the integrated jukebox with touch screen unit 130 includes an LCD monitor 200 and a touch screen 202. While shown as separate devices in FIG. 2, in practice the touch screen 202 is positioned on top of the viewable screen of the LCD monitor 200. In this way, the LCD Monitor 200 displays selectable options to the user, for example, as push buttons. When the user “depresses” the button displayed by the LCD monitor 200, the touch screen 202 responds appropriately.

The LCD monitor 200 and touch screen 202 are connected to a main motherboard 204. The LCD monitor 200 is connected to the monitor output of the main motherboard 204. The touch screen 202 is connected to the main motherboard via a USB driver 206 and USB Port 208. The remaining USB Port 208 is connected to a removable hard drive 210. The removable hard drive contains the music database 102. The removable hard drive 210 is connected to the USB Port 208 via a USB plug 211 and USB slot 213.

The main motherboard 204 includes a CPU 212 and RAM 214, and is connected to a flash card 216 via a flash card adapter 218 and IDE bus 220. The flash card 216 stores software that is executed by the CPU 212. The music selector module 106, music player module 108, and music queue 122 are implemented in software stored on the flash card 216 and executed by the CPU 212.

Power is delivered to the main motherboard 204 from an AC source 222 via an AC/DC transformer 224 and power supply 226. Power is controlled by an on/off switch 228. A fan 215 cools the CPU 212 and main motherboard 204.

The main motherboard 204 is also connected to the internet 116 via suitable internet connection devices 250, 252. For example, the main motherboard 204 may be configured with an on-board network connector 250, for receiving an RJ-45 connector device.

The CPU 212 selectively retrieves and plays digital audio files from the music database 102 on the removable hard drive 210 and from the internet 116 in response to user input received from the touch screen 202. The audio output generated by the CPU is delivered to female RCA audio plugs 230. Other suitable audio outputs may be used. The audio output is delivered to the Receiver/Amplifier 124 via corresponding male RCA plugs 232.

In practice, the integrated jukebox with touch screen unit 130 is mountable and may be located in a bar, restaurant, recreation room, or the like. The integrated jukebox with touch screen unit may be mounted to a wall, a counter-top, a bar-top, or other suitable location. Additionally, the integrated jukebox with touch screen unit 130 may be mounted or located in a vehicle, such as a limousine, car, bus, recreational vehicle, or airplane. The music database 102 on the removable hard drive 210 is loaded with CDs and then connected to the integrated jukebox with touch screen unit 130 via the USB plug 211 and USB slot 213.

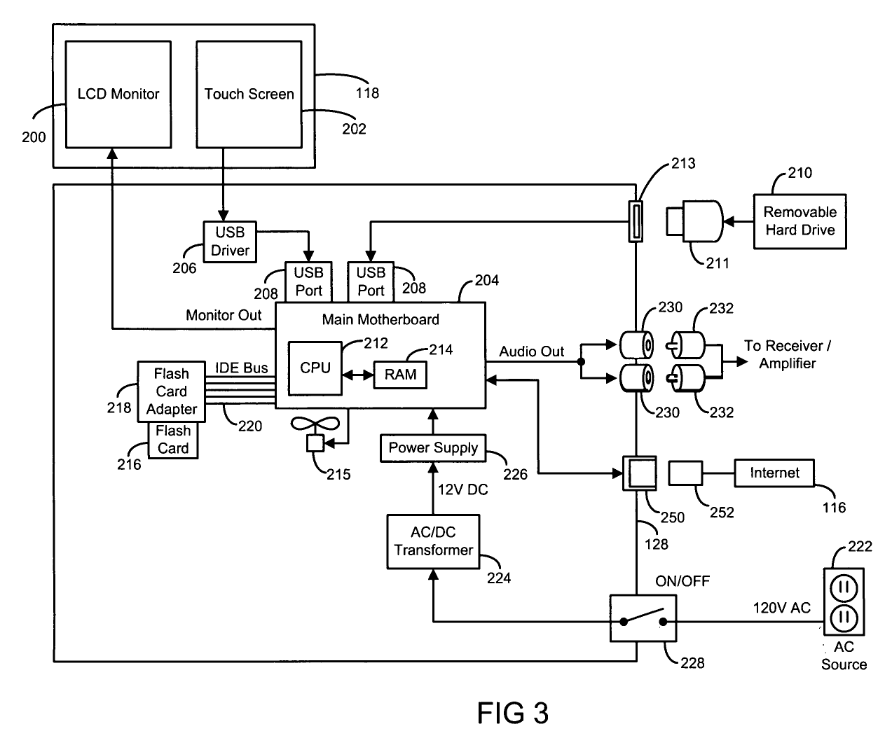

With reference to FIG. 3, the integrated jukebox unit 128 is similar to the integrated jukebox with touch screen unit 130 of FIG. 2. The integrated jukebox unit 128 is separate, however, from the touch screen I/O module 118, comprised of the LCD monitor 200 and touch screen 202. In practice, the touch screen I/O module 118 may be mounted to a wall, a counter-top, a bar-top, or other suitable location. The integrated jukebox unit 128 may then be hidden from view under the counter-top, bar-top, or the like. In all other respects, the integrated jukebox unit 128 and the integrated jukebox with touch screen unit 130 include similar components and operate in a similar fashion.

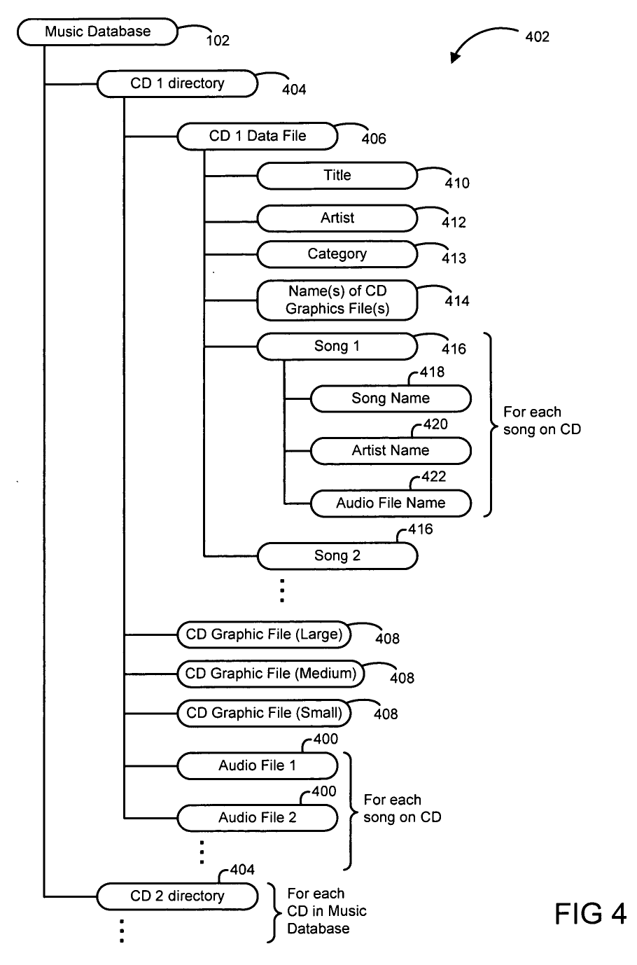

Referring now to FIG. 4, digital audio files 400 and other music data are stored in a data structure 402 in the music database 102. The data structure 402 includes a separate CD directory 404 for each CD stored in the music database 102. Each CD directory includes a CD data file 406, CD graphics files 408, and an audio file 400 for each song on the CD. The CD data file 406 includes the title 410 and artist 412 as well as the name of the associated CD graphics file(s) 414. The CD data file 406 includes the category 413 of the CD, e.g., pop/rock, r & b, etc. The CD data file 406 contains a song entry 416 for each song on the CD. Each song entry 416 includes the song name 418, artist name 420, and associated audio file name 422. The artist name 420 will be identical to the artist field 412 if the artist is the same for all songs on the CD. If the CD includes various artists, then the artist name 420 will vary across the songs on the CD.

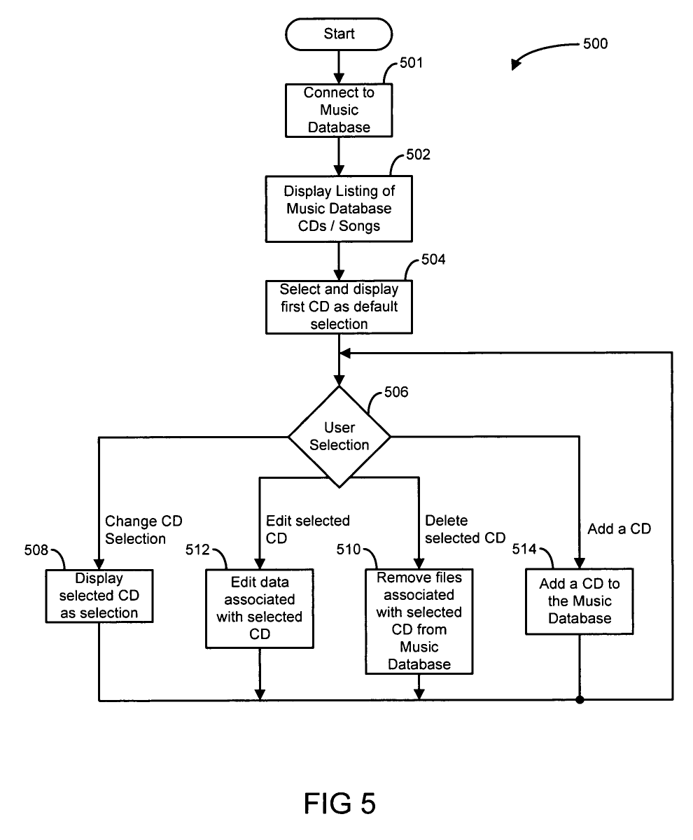

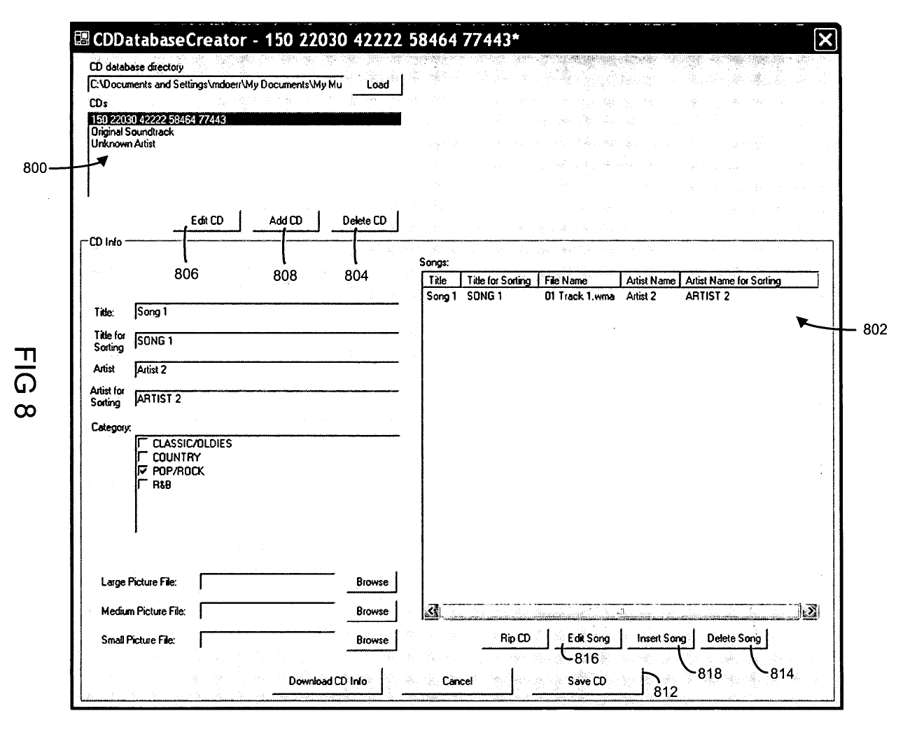

Referring now to FIG. 5, a music data management algorithm 500 is shown. The music data management algorithm 500 is executed by the music creator module 104. In step 501, the music creator module 104 connects to the music database 102. The music creator module 104 retrieves a listing of CDs and a listing of songs for each CD from the music database 102. In step 502 the music creator module 104 displays a listing of the CDs. With additional reference to FIG. 8, a screen shot shows the CD list 800. In step 504 (FIG. 5) the first CD in the list is selected and displayed as the default selection. As shown in FIG. 8, the first CD in the CD list 800 is highlighted. In FIG. 8 a screen shot of music data management options is shown. The songs for the selected CD are shown in the song list 802 (FIG. 8).

In step 506 (FIG. 5), the user is presented with a number of options. The user may change the CD selection, edit the selected CD, delete the selected CD, or add a CD. To change the CD selection, the user highlights a different CD in the CD list 800 (FIG. 8). When the user changes the CD selection, the newly selected CD is displayed as the current CD selection in step 508 (FIG. 5). The songs associated with the new CD selection are displayed in the song list 802 (FIG. 8). After displaying the current CD selection, the music creator module 104 returns to step 506 and waits for the next user input.

The user may delete the selected CD by pressing the delete CD button 804 (FIG. 8). When the user selects delete CD, the music creator module 104 removes the files associated with the selected CD from the music database in step 510 (FIG. 5). To remove the files associated with the selected CD, the music creator module 104 deletes the associated CD directory from the music database 102. The music creator module 104 then returns to step 506 and waits for the next user input.

The user may edit the data associated with the selected CD by pressing the edit CD button 806 (FIG. 8). As described in more detail below, the music creator module 104 edits the data associated with the selected CD, based on user input, in step 512 (FIG. 5). The music creator module 104 then returns to step 506 and waits for the next user input.

The user may add a CD to the music database 102 by pressing the add CD button 808 (FIG. 8). As described in more detail below, the music creator module 104 adds a CD to the music database 102 in step 514 (FIG. 5). The music creator module 104 then returns to step 506 and waits for the next user input.

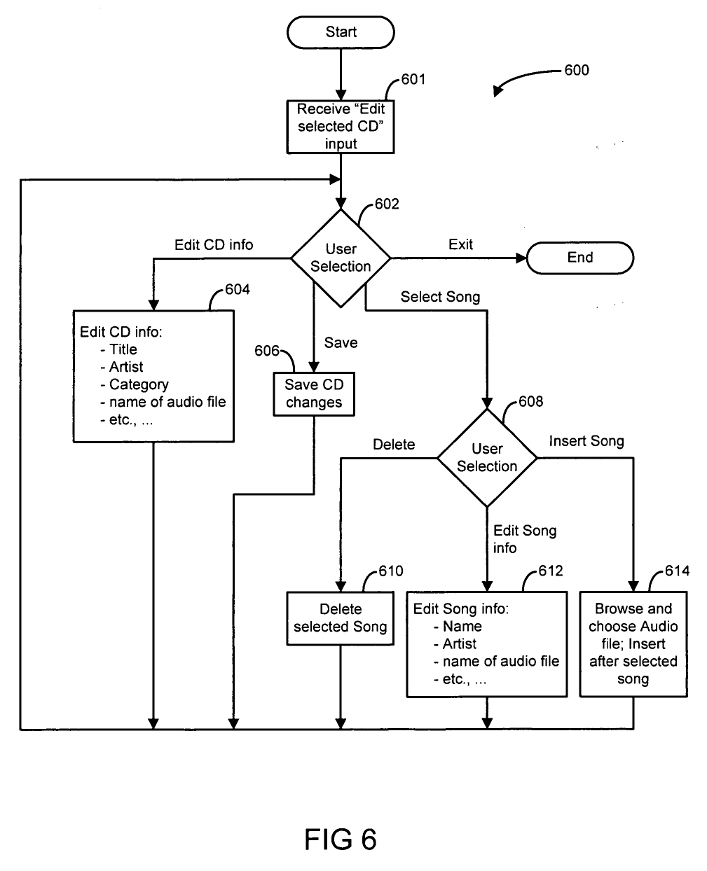

With reference now to FIG. 6, a music data modification algorithm 600 is shown. The music data modification algorithm 600 is executed by the music creator module 104 when the user presses the edit CD button 806 (FIG. 8). It is understood that the steps shown in FIG. 6 are encapsulated in step 512 of FIG. 5. In step 601, the music creator module 104 receives the “edit selected CD” input from the user. The user is presented with various choices in step 602.

The user may choose to edit CD info. In step 604, the music creator module 104 edits the selected informational data based on user input. The CD title, artist, category, names of audio files, etc., may be edited in step 604. Editable text boxes are provided to edit CD data 810 (FIG. 8). The music creator module 104 returns to step 602 and waits for user input.

The user may save the CD changes by pressing the Save CD button 812 (FIG. 8). The music creator module 104 saves the CD changes to the music database 102 in step 606 (FIG. 6).

The user may select a specific song to edit from the song list 802. (FIG. 8). The music creator module 104 then waits for a user selection in step 608 (FIG. 6). When a specific song is selected for editing, the user may delete the selected song by pressing the delete song button 814 or edit the song information by pressing the edit song button 816 (FIG. 8). When the delete song button 814 is depressed, the music creator module 104 deletes the selected song from the music database 102 in step 610 and returns to step 602 (FIG. 6).

When the edit song button 816 (FIG. 8) is depressed, the music creator module 104 edits song information in step 612 (FIG. 6). The user may edit the song name, artist, name of associated audio file, etc. The music creator module 104 then returns to step 602.

The user may insert a song by depressing the insert song button 818 (FIG. 8). The music creator module 104 inserts a song after the selected song in the song list 802. In step 614 (FIG. 6), the user browses and chooses an audio file for insertion after the selected song. The audio file may be retrieved from the CD Drive 110, from the internet 116, or from another suitable music source. The music creator module 104 then returns to step 602. When the CD and song editing is finished, the music creator module 104 exits the edit CD algorithm 600.

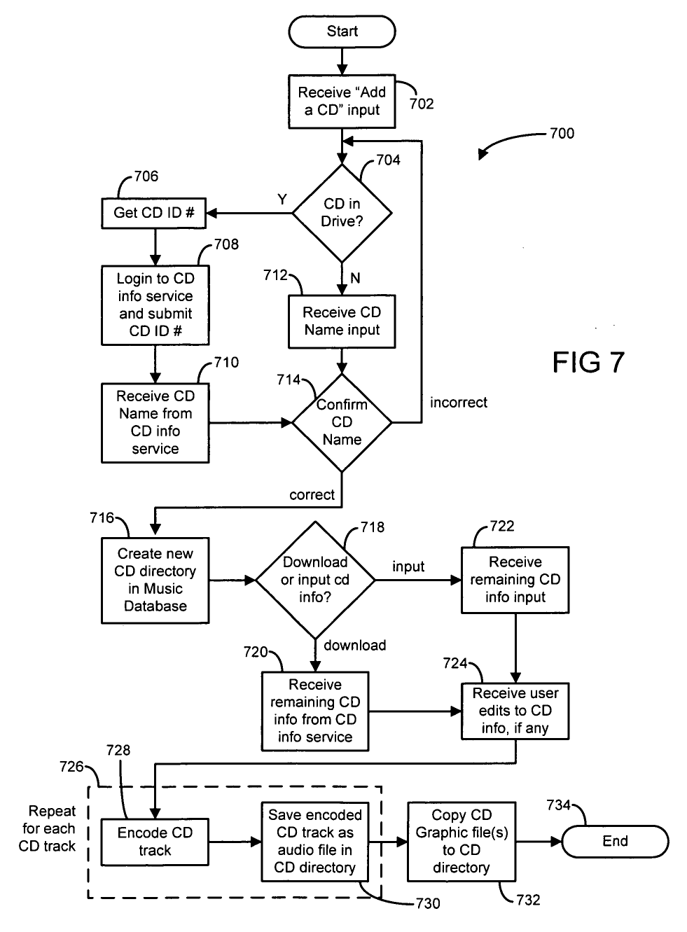

With reference now to FIG. 7, a music data creation algorithm 700 is shown. The music data creation algorithm 700 is executed by the music creator module 104 to add a CD to the music database 102. It is understood that the steps shown in FIG. 7 are encapsulated in step 514 of FIG. 5.

In step 702, the music creator module 104 receives the “Add CD” input from the user. With reference to FIG. 8, the user depresses the add CD button 808. In step 704 (FIG. 7), the music creator module 104 determines whether a CD is in the CD Drive 110. When a CD is in the CD Drive 110, the music creator module 104 proceeds to step 706 and gets the encoded CD number from the CD. Music CDs contain a unique encoded CD number that identifies the music data, such as artist, CD title, etc. In step 708, the music creator module 104 logs in to a CD information service and submits the encoded CD number. For example, a CD information service, such as CDDB provided by Gracenote®, provides CD information via the internet based on the encoded CD number. In step 710, the music creator module 104 receives the CD Name from the CD information service based on the encoded CD number.

In step 704 when a CD is not in the CD Drive 110, the music creator module 104 proceeds to step 712. In step 712, the user is prompted for the name of the CD. The music creator module 104 receives the CD name input, and proceeds to step 714. In step 714, the user confirms the CD name. When the CD name is not correct, the music creator module 104 loops back to step 704. When the CD Name is correct, the music creator module 104 proceeds to step 716.

In step 716, the music creator module 104 creates a new CD directory in the music database 102 for the CD. In step 718, the user selects whether to download CD information from the CD information service, or to manually input the CD information. When the user selects download, the remaining CD information is retrieved from the CD information service in step 720. When the user selects manual input, the music creator module 104 receives the CD information input in step 722. In step 724, the music creator module 104 receives any user edits to the CD information.

When the CD information is complete, the music creator module 104 repeats an encoding loop 726 for each song track on the CD. In step 728, the CD track is encoded. In step 730, the encoded CD track is saved as an audio file in the appropriate CD directory in the music database 102.

In step 732, the CD graphic files are copied to the CD directory. The CD graphic files may include CD cover artwork and the like. The music data creation algorithm 700 ends in step 734.

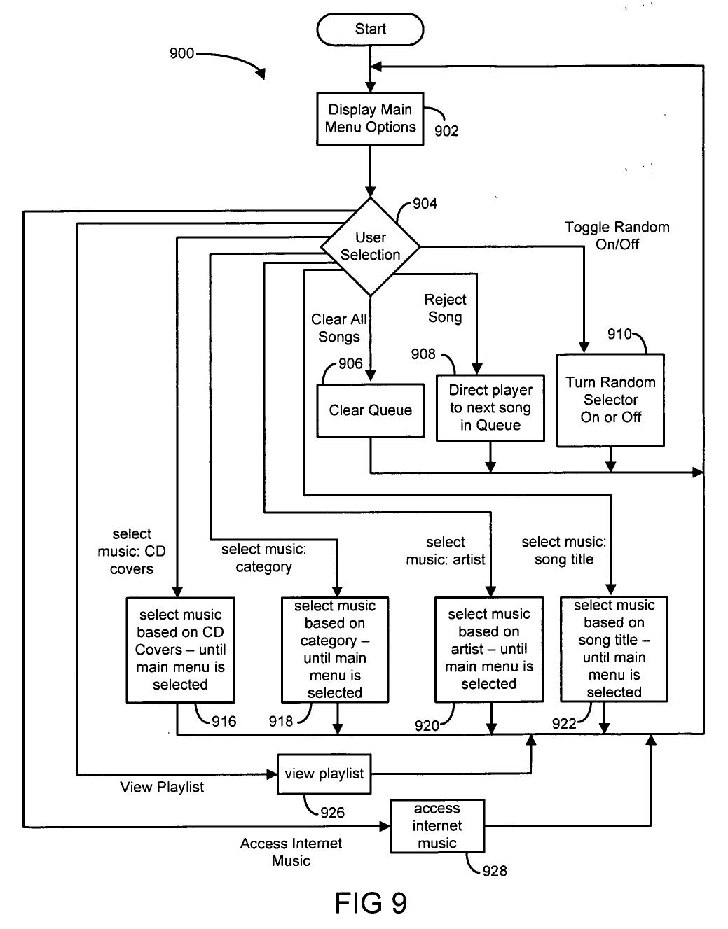

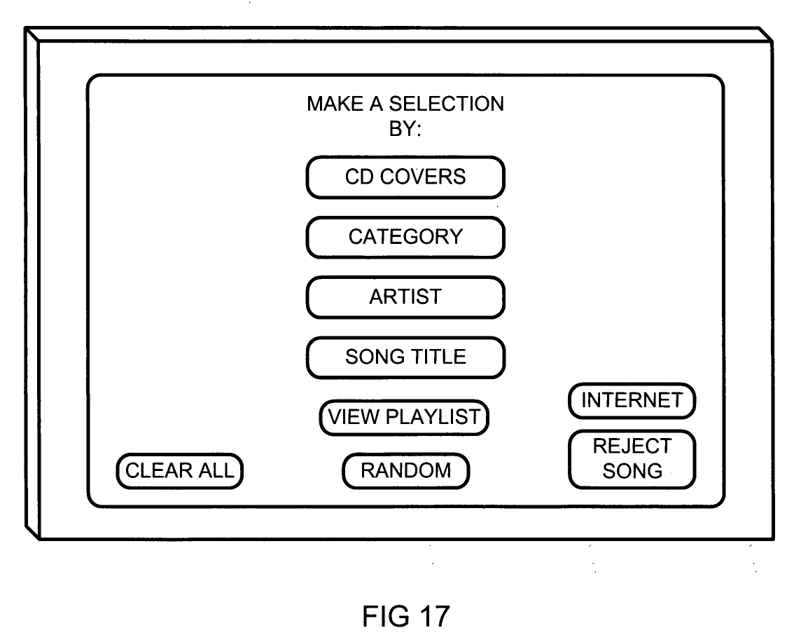

With reference now to FIG. 9, a music selection algorithm 900 is executed by the music selector module 106. The music selection algorithm 900 is executed by the music selector module 106 after the music database is connected to the music selector module 106. For example, the music selection algorithm 900 may be executed after the removable hard drive 210 is connected. In step 902, the main menu options are displayed. The main menu options include: select music options, clear all songs, reject song, toggle random on/off, view playlist, and access internet music. With reference to FIG. 17, a screenshot of music selection options is shown. The screenshot is displayed by the touch screen I/O module 118. It is understood that the touch screen I/O module 118 shown in FIG. 17 may or may not be integrated with the music selector module 106, music player module, music queue 122, and computer-readable medium 120.

In step 904, when the user selects “clear all songs,” the music selector module 106 clears all songs from the music queue 122 in step 906. The music selector module 106 then returns to step 902 and displays the main menu options again.

In step 904, when the user selects “reject song,” the music selector module 106 clears the current song from the music queue 122 in step 908, and skips to the next song in the music queue 122. The music selector module 106 then returns to step 902 and displays the main menu options again.

In step 904, when the user selects “toggle random on/off,” the music selector module 106 toggles a random-enable flag in step 910. When the random-enable flag is on, the music selector module 106 retrieves a random song from the music database 102 when the music queue 122 is empty. When the random-enable flag is off, the music queue 122 remains empty when the last song from the music queue 122 finishes playing. The music selector module 106 returns to step 902 and displays the main menu options again.

In step 904, when the user desires to select music to play, the user may select music by CD Cover, by category, by artist, and by song title. Music is selected based on CD covers in step 916, based on category in step 918, based on artist in step 920, and based on song title in step 922. When music is selected in steps 916, 918, 920 and 922, the music selector module 106 adds the selected music to the music queue. When a single song is selected, the song is added to the end of the music queue. When an entire CD is selected, all of the songs of the selected CD are added to the end of the music queue 122 in order.

The user generally continues to select music until the user selects a “return to main menu” option, wherein the music selector module 106 returns to step 902 and displays the main menu options again.

In step 904, when the user selects view playlist, the playlist is displayed for viewing in step 926. When the playlist is displayed, the current song being played is displayed along with the songs to be played next. For example, the next fifteen songs “waiting” in the Music Queue 122 may be displayed.

In step 904, when the user selects the internet option, internet music is accessed in step 928. The user may select an internet radio broadcast to be played. Alternatively, the user may select an internet music website with digital music files available for downloading. In such case, the user may download digital music files directly from the website. The downloaded music files are stored in the music database 102 and placed in the Music Queue 122 for playing by the Music Player Module 108.

The integrated jukebox unit 128 may be equipped with suitable input/output connections to allow communication with a keyboard and/or mouse (not shown). For example, the integrated jukebox unit 128 may include an IR keyboard/mouse connection to allow internet browsing by the integrated jukebox unit 128.

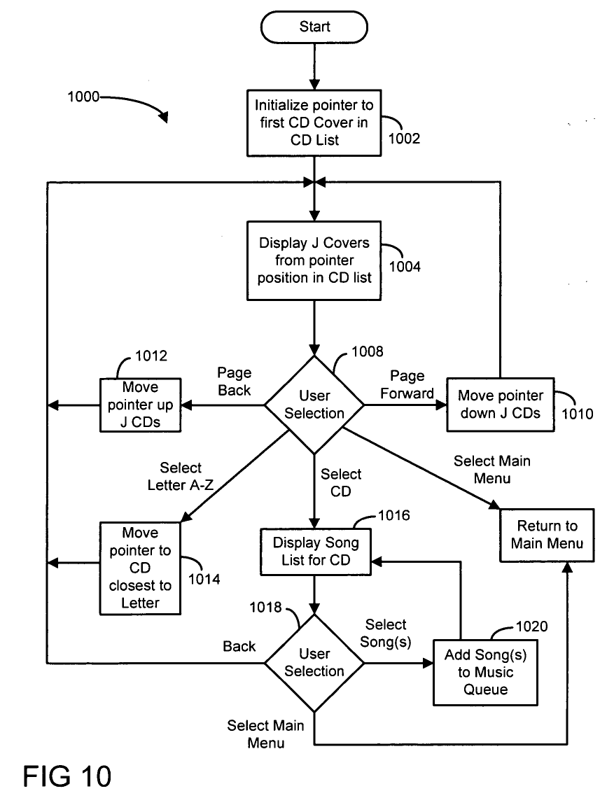

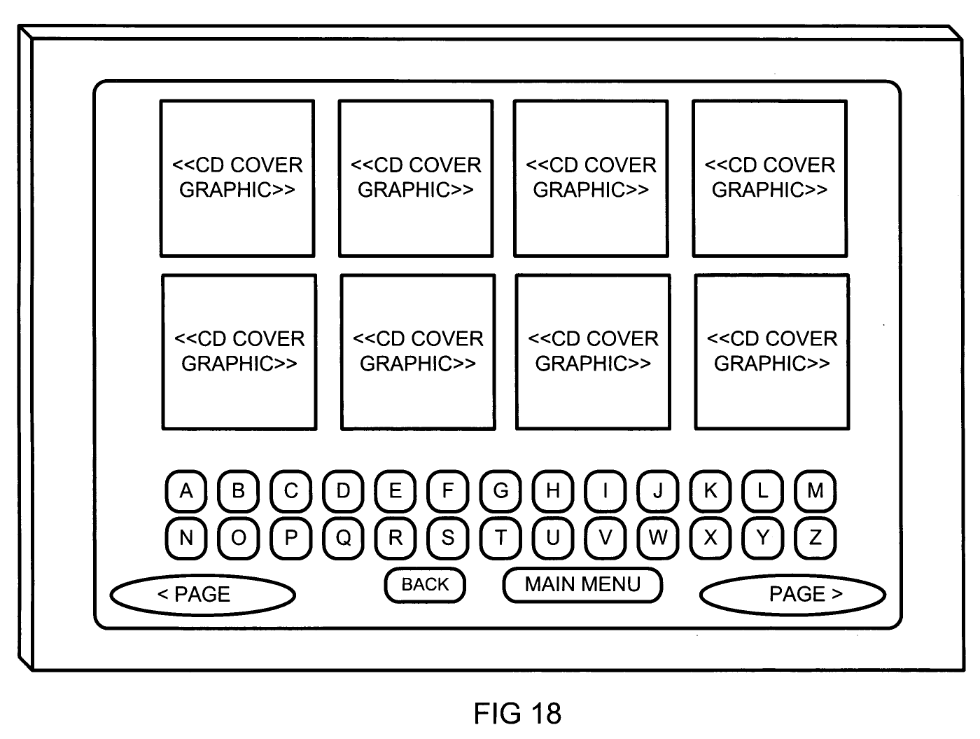

With reference now to FIG. 10, a music selection by cover algorithm 1000 is executed by the music selector module 106. It is understood that the steps shown in FIG. 10 to select music based on CD cover correspond to step 916 of FIG. 9. In step 1002, the music selector module 106 initializes a pointer to the first CD cover in the CD list. The CD list is a listing of all CDs in the music database 102. The CD list may be organized alphabetically, or by other suitable organizational means. In step 1004, the music selector module 106 displays “J” Covers from the pointer position in the CD list, where J is a predetermined number. For example, with reference to FIG. 18, 8 CD covers are displayed on the touch screen I/O module 118. In FIG. 18 a screenshot of music selection by cover options is shown.

In step 1008, the user selection is received. The user may page forward or page back. When page forward is selected, the music selector module 106 moves the pointer down J CDs in step 1010, and displays the next J CDs in the CD list in step 1004. When page back is selected, the music selector module 106 moves the pointer up J CDs in step 1012, and displays the previous J CDs in the CD list in step 1004.

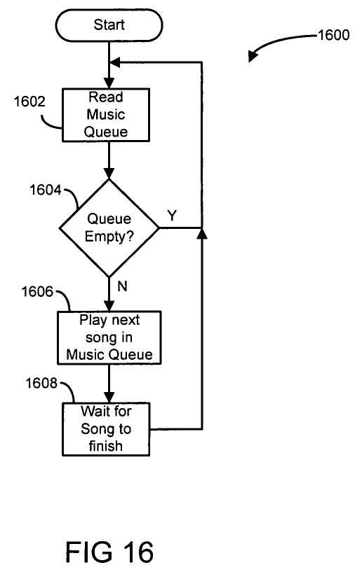

The user may select an alphabet letter by pressing a letter displayed on the touch screen I/O module 118, as shown in FIG. 16. When the user selects an alphabet letter, the music selector module 106 moves the pointer to the CD in the CD list closest to the selected letter in step 1014. The music selector module 106 then returns to step 1004 and displays J covers from the pointer position in the CD list.

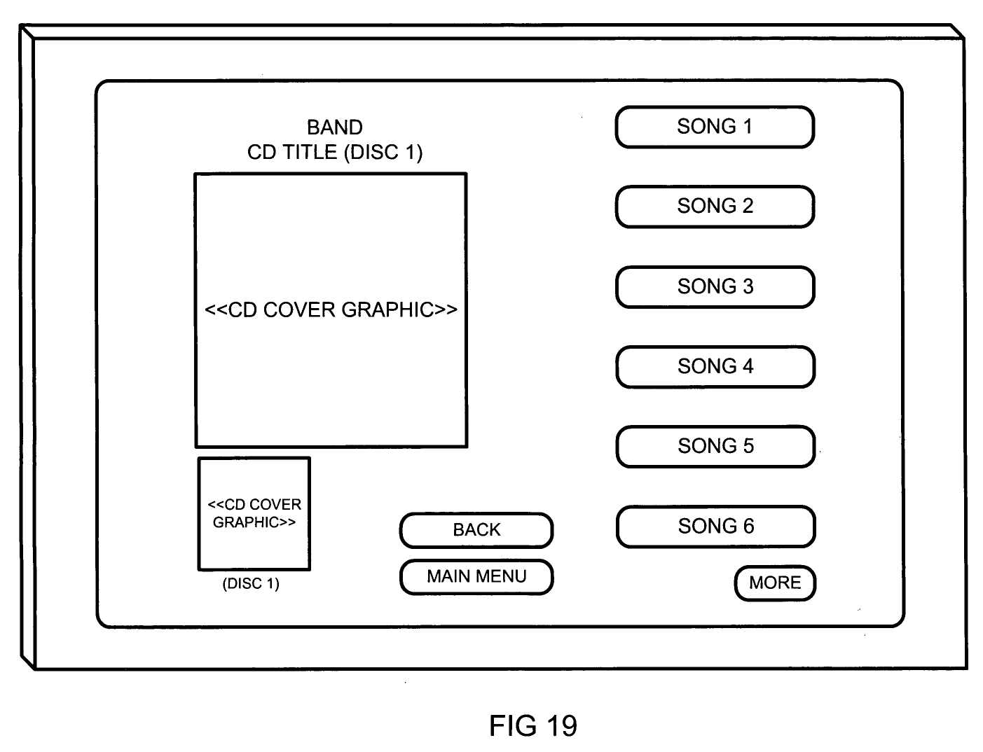

When the user selects one of the CD covers, the song list for the selected CD is displayed in step 1016. With reference to FIG. 19, when a CD is selected, the CD Cover is displayed alongside a listing of the songs of the CD. In FIG. 19, a screenshot of music selection by cover options is shown. When the particular CD is part of a multi-disc set, the covers of the other CDs in the multi-disc set are displayed as smaller CD Cover graphics below the current selected CD.

The user selection from the song list is received in step 1018. The user may select a single song from the CD's song list. The user may also select all of the songs from the CD's song list. When music is selected in step 1018, the selected music is added to the music queue 122 in step 1020. After selecting a song or songs from the song list in step 1020, the song list continues to be displayed in step 1016. The user may continue to select songs from the CD until selecting “Back” or “Return to Main Menu” in step 1018. When the user selects “Back,” the CD covers are again displayed in step 1004.

In both step 1008 and step 1018, the user may select to return to the main menu. When the main menu is selected, the music selector module 106 returns to step 902 (FIG. 9) and displays the main menu options. In step 1018, the user may select “Back” without selecting any music. When “Back” is selected, the music selector module 106 returns to step 1004 and displays J covers from the current pointer position in the CD list.

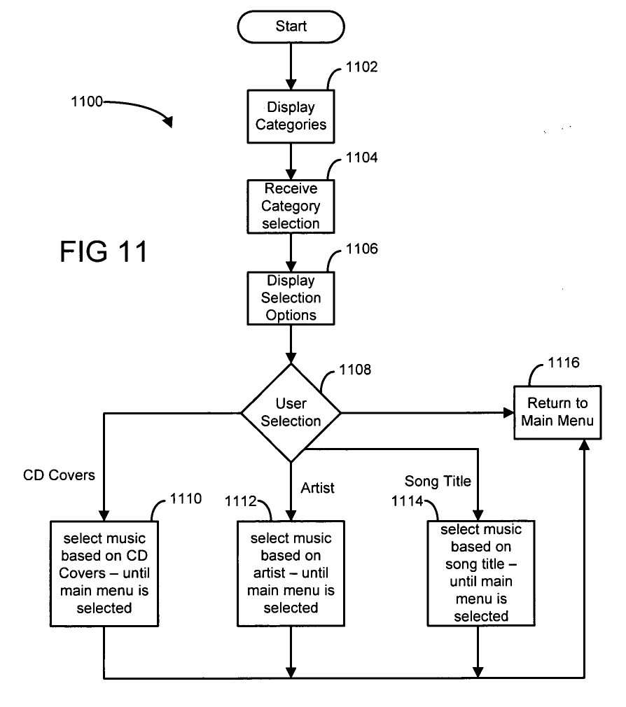

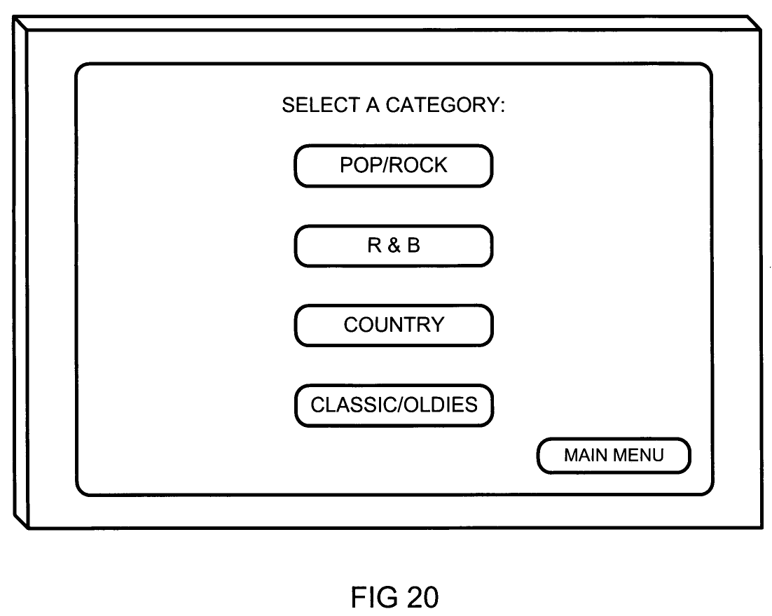

With reference now to FIG. 11, a selection by category algorithm 1100 is executed by the music selector module 106. It is understood that the steps shown in FIG. 11 to select music based on category correspond to step 918 of FIG. 9. In step 1102 music categories are displayed. With reference to FIG. 20, for example, music categories are displayed on the touch screen I/O module 118, including Pop/Rock, R & B, Country, and Classic/Oldies. In step 1104 the category selection is received. In step 1106, the display selection options are displayed.

The user may select based on CD covers, artist, or song title. The user selection is received in step 1108. When the user chooses to browse by CD covers, music is selected based on CD covers from within the selected category of music in step 1110. When the user chooses to browse by artist, music is selected based on artists from within the selected category of music in step 1112. When the user chooses to browse by song title, music is selected based on song title from within the selected category of music in step 1114. The user may also choose to return to the main menu in step 1116.

When music is selected in steps 1110, 1112, and 1114, the selected music is added to the music queue 122. When the music selection concludes, the algorithm returns to the main menu in step 1116.

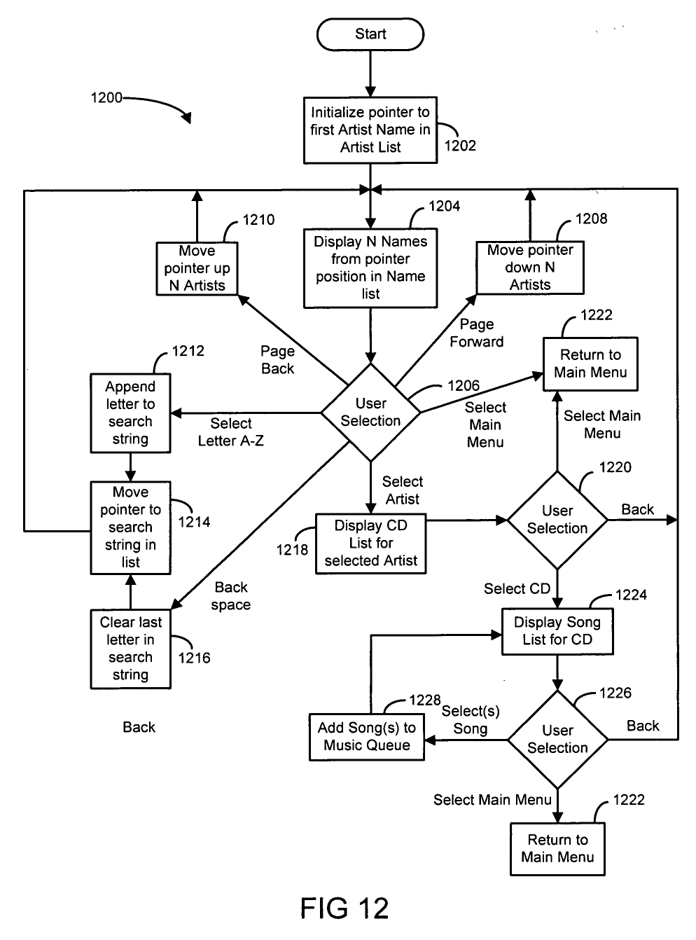

With reference now to FIG. 12, a selection by artist algorithm 1200 is executed by the music selector module 106. It is understood that the steps shown in FIG. 12 to select music based on artist name correspond to step 920 of FIG. 9. In step 1202, a pointer is initialized to the first artist name in an artist list. The artist list is a listing of all artists in the music database 102. The artist list may be organized alphabetically, or by other suitable organizational means.

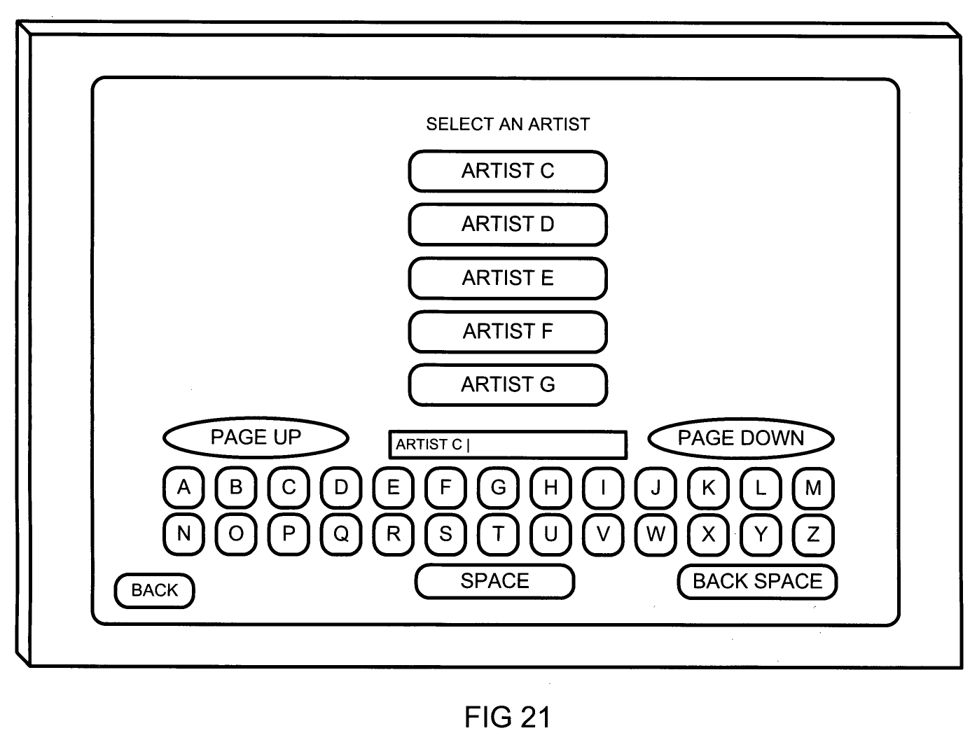

In step 1204, the music selector module 106 displays N names from the current pointer position in the name list. “N” is a predetermined number of artist names. For example, with reference to FIG. 21, five artists are displayed on the touch screen I/O module 118. In step 1206 a user selection is received. The user may choose to page forward, page back, select a letter A-Z, back space, select an artist, or return to main menu.

In step 1206, when the user chooses page forward, the pointer is moved down N artists in the name list in step 1208. The music selector module 106 then displays N names from the current pointer position in the name list in step 1204. In step 1206, when the user chooses page back, the pointer is moved up N artists in the name list in step 1210. The music selector module 106 then displays N names from the current pointer position in the name list in step 1204.

In step 1206, when the user chooses to select a letter A-Z, the selected letter is appended to a search string in step 1212. In step 1214, the pointer is moved to the location in the name list corresponding to the current search string. For example, with reference to FIG. 21, “Artist C” has been entered as the search string. Artist C, followed by the 4 artist names which follow Artist C in the name list, are displayed on the touch screen I/O module 118 in FIG. 21. In step 1216, when the user chooses to back space, the last letter from the search string is cleared. The pointer is moved to the location in the name list corresponding to the current search string in step 1214. The music selector module 106 then returns to step 1204 and displays N names from the current pointer position in the name list.

When an artist is selected from the name list, the list of CDs for the selected artist is displayed in step 1218. The user then makes a selection in step 1220. The user may select a CD, go back to the Name List display, or Return to the Main Menu. The user selection based on the displayed Song List is received in step 1226. In step 1226, the user may select a song or songs from the Song List, go Back to the Name List, or Return to the Main Menu.

In step 1226 the user may select a song from the Song List, or all of the Songs on the Song List for the CD. The selected songs are added to the Music Queue in step 1228. After the songs are added to the music queue, the song list is again displayed in step 1224.

In steps 1206, 1220 and 1226, when the user selects “Back”, the Name List is displayed in step 1204. In steps 1206, 1220, and 1226, the user may choose to return to the main menu. The music selector module 106 returns to the main menu in step 1222, and proceeds with the main menu selection algorithm 900.

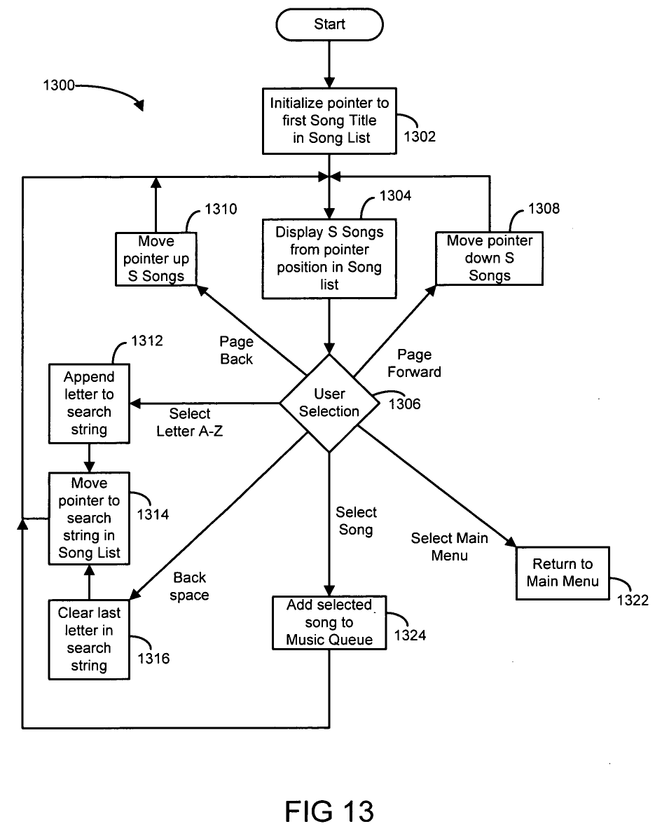

With reference now to FIG. 13, a selection by song title algorithm 1300 is executed by the music selector module 106. It is understood that the steps shown in FIG. 13 to select music based on song title correspond to step 922 of FIG. 9. In step 1302, a pointer is initialized to the first song title in a song list. The song list is a listing of all songs in the music database 102. The song list may be organized alphabetically, or by other suitable organizational means.

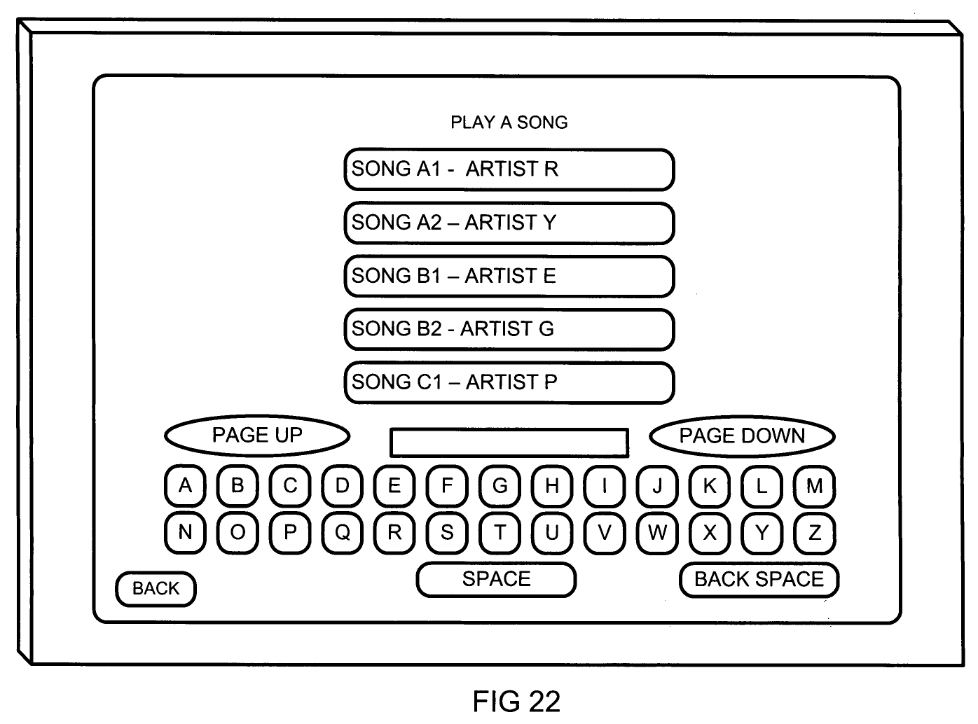

In step 1304, the music selector module 106 displays S songs from the current pointer position in the song list. “S” is a predetermined number of songs. For example, with reference to FIG. 22, five songs are displayed on the touch screen I/O module 118. In step 1306 a user selection is received. The user may choose to page forward, page back, select a letter A-Z, back space, select a song, or return to main menu.

In step 1306, when the user chooses page forward, the pointer is moved down S songs in the song list in step 1308. The music selector module 106 then displays S songs from the current pointer position in the song list in step 1304. In step 1306, when the user chooses page back, the pointer is moved up S songs in the song list in step 1310. The music selector module 106 then displays S songs from the current pointer position in the song list in step 1304.

In step 1306, when the user chooses to select a letter A-Z, the selected letter is appended to a search string in step 1312. In step 1314, the pointer is moved to the location in the song list corresponding to the current search string. In step 1316, when the user chooses to back space, the last letter from the search string is cleared. The pointer is moved to the location in the song list corresponding to the current search string in step 1314. The music selector module 106 then returns to step 1304 and displays S songs from the current pointer position in the song list.

When a song is selected from the song list, the selected music is added to the music queue 122 in step 1324. In step 1306 the user may choose to return to the main menu. The music selector module 106 returns to the main menu in step 1322, and proceeds with the main menu selection algorithm 900.

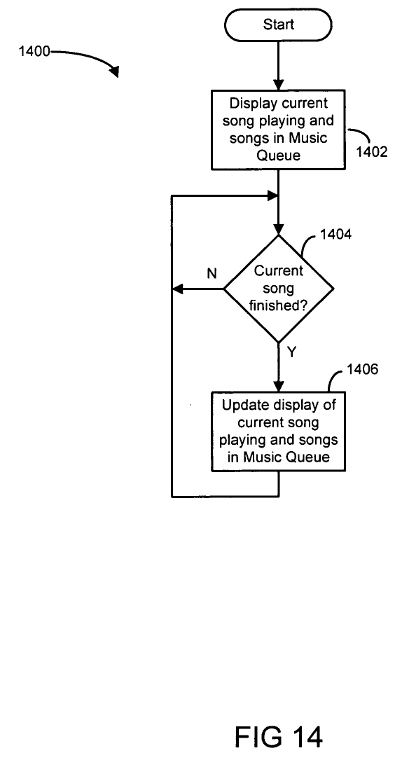

Referring now to FIG. 14, a playlist display algorithm 1400 is executed by the music selector module 106. It is understood that the steps shown in FIG. 14 correspond to step 926 of FIG. 9. In step 1402 the current song being played along with additional songs in the music queue 122 are displayed. The user may select the number of “waiting” songs to be displayed. For example, the user may select that five, ten, or fifteen upcoming songs be displayed. In step 1404, the music selector module 106 determines whether the current song is finished. When the current song is not finished, the music selector module 106 loops back to step 1404 and the current display remains unchanged. When the current song is finished, the display is updated with the next current song and with the current songs “waiting” in the music queue 106 in step 1406. The music selector module 106 then loops back to step 1404.

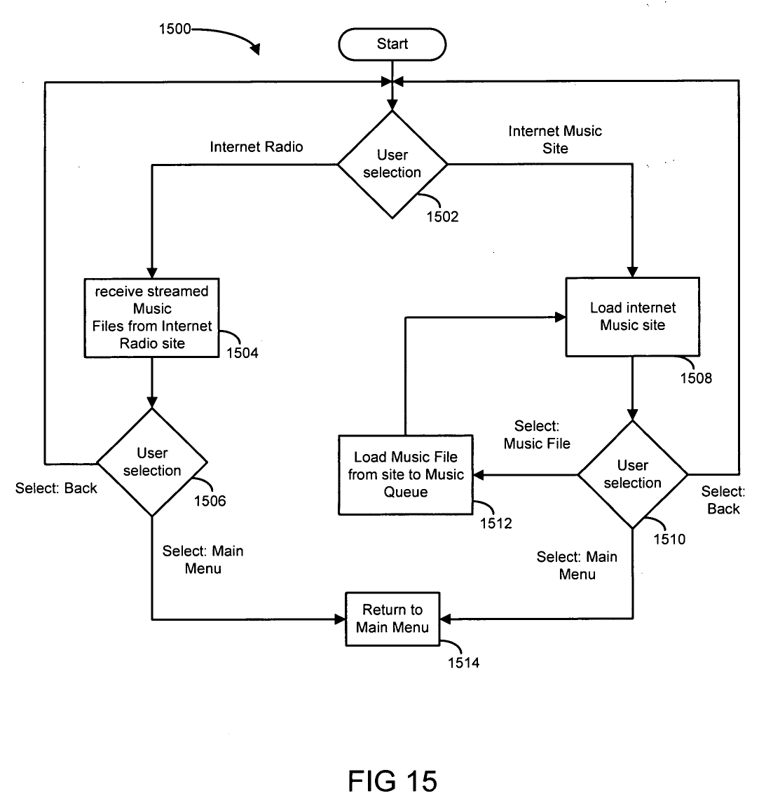

Referring to FIG. 15, an algorithm for accessing music on the internet is executed by the music selector module 106. In step 1502 a user selection is received. The selection may include an internet radio selection or an internet music site selection.

In step 1504, when internet radio is selected, the music selector module 106 receives streamed music files from the selected internet radio web site. The internet radio web site may broadcast an internet radio program comprising a series of music files for play. The internet radio broadcast is played until a user selection is received in step 1506. In step 1506, the user may select “back” to return to step 1502 or “main menu” to return to the main menu in step 1514.

In step 1502, when the user selection an internet music site, the selected internet music site may be displayed in step 1508. The user may browse the internet to arrive at the desired internet music site. As described above, input/output devices such as an IR keyboards and/or an IR mouse may be used to facilitate internet browsing. In step 1508 the selected internet music site is loaded for viewing.

In step 1510 the user makes a selection based on the loaded web site. The user may select to return to the main menu and proceed to step 1514. The user may select “back” to return to step 1502. Additionally, the user may select a music file from the website. In such case, the selected music file is downloaded in step 1512. The selected music file is stored in the music database 102 and inserted in the music queue 122. After downloading the music file, the internet music site is again loaded or renewed in the display in step 1508. In this way, internet music is accessed by the music selector module 106.

Referring to FIG. 16, a music player algorithm 1600 is executed by the music player module 108. In step 1602 the music player module 108 reads the music queue 122. In step 1604, the music player module 108 determines whether the music queue 122 is empty, the music player module 108 loops back to step 1602. When in step 1604 the music queue is not empty, the music player module 108 proceeds to step 1606 and plays the next song in the music queue 122. When the music player module 108 plays a song, it is outputted to the female RCA audio plugs 230 (FIGS. 2 and 3). In step 1608 the music player module 108 waits for the song to finish. When the song finishes, the music player module 108 proceeds to step 1402 and reads the music queue 122 again.

In this way, music is selected and played on the virtual jukebox music system 100. CDs are loaded into the music database 102. Music fans may then gather around the touch screen I/O module 118 either as part of an integrated jukebox with touch screen unit 130 or as part of a separate from an integrated jukebox unit 128. Music selections are made either from the music database 102 or from the internet and loaded into the music queue 122.

What is claimed is:

1. A virtual jukebox music system comprising:
a music database stored in a removable hard drive;
a music creator module connected to a CD drive, at least one input module, and a first computer readable medium for storing at least one music data management algorithm executable by said music creator module,
a music player module that plays music files in a music queue, and
a music selector module connected to a touch screen input/output module, said music player module, said music queue, and a second computer readable medium for storing at least one music selection algorithm executable by said music selector module,
wherein:
said music database is selectively connectable to said music selector module and said music creator module;
said at least one music data management algorithm includes instructions for said music creator module to retrieve music files from said CD drive, convert said music files to a predetermined music database format, and store said music files in said music database; and
said at least one music selection algorithm includes instructions for said music selector module to selectively retrieve said music files from said music database and place said music files in said music queue in response to input received from said touch screen input/output module.

2. The virtual jukebox music system of claim 1, wherein said at least one music data management algorithm includes a music data modification algorithm for modifying data including at least one of a CD title, an artist name, and a CD music category.

3. The virtual jukebox music system of claim 1, wherein said at least one music selection algorithm includes a selection by cover algorithm for selecting a music file to be placed in said music queue from a display of multiple CD covers.

4. The virtual jukebox music system of claim 1, wherein said at least one music selection algorithm includes a selection by category algorithm for selecting a music file to be placed in said music queue based on a desired category of music.

5. The virtual jukebox music system of claim 1, wherein said at least one music selection algorithm includes a selection by artist algorithm for selecting a music file to be placed in said music queue based on a listing of artist names.

6. The virtual jukebox music system of claim 1, wherein said at least one music selection algorithm includes a selection by title algorithm for selecting a music file to be placed in said music queue based on a listing of song titles.

7. The virtual jukebox music system of claim 1, wherein said at least one music selection algorithm includes instructions for said music selector module to display main menu options simultaneously viewable on said touch screen input/output module, said main menu options including:
a selection by cover option, which initiates a selection by cover algorithm;
a selection by category option, which initiates a selection by category algorithm;
a selection by artist option, which initiates a selection by artist algorithm;
a selection by song title option, which initiates a selection by title algorithm;
a clear all songs option, which initiates a selection by songs algorithm;
a random option, which initiates a random song selection algorithm which places randomly selected music files in said music queue; and
a reject song option, which moves said music player module to a next music file in said music queue.

8. The virtual jukebox music system of claim 1 further comprising a virtual jukebox music system housing, wherein:
said music player module and said music selector module are housed within said virtual jukebox music system housing;
said touch screen input/output module is attached to said virtual jukebox music system housing; and
said virtual jukebox music system housing includes at least one audio output for connection to audio speakers.

9. The virtual jukebox music system of claim 8 wherein said virtual jukebox music system housing is mountable to at least one of: a vertical surface and a horizontal surface.

10. The virtual jukebox music system of claim 9 wherein said virtual jukebox music system is mountable to an interior of a vehicle.

11. The virtual jukebox music system of claim 7 further comprising a virtual jukebox music system housing, wherein:
said music player module and said music selector module are housed within said virtual jukebox music system housing;
said touch screen input/output module is attached to said virtual jukebox music system housing; and
said virtual jukebox music system housing includes at least one audio output for connection to audio speakers.

12. The virtual jukebox music system of claim 1 wherein said at least one music data management algorithm includes instructions for said music creator module to retrieve music files from a computer network.

13. The virtual jukebox music system of claim 1 wherein said music selector module displays a music playlist including a current song being played and at least one additional song to be played after the current song.

14. The virtual jukebox music system of claim 1 wherein said music selector module is connected to a computer network and receives at least one music file from said computer network for storing in said music database and for placement in said music queue.

15. The virtual jukebox music system of claim 1 wherein said music selector module is connected to an internet website and receives at least one music file via an internet radio broadcast from said internet website.

16. A method comprising:
receiving music files from at least one of a CD drive and a computer network;
storing said music files in a music database contained in a removable hard drive;
connecting said removable hard drive to a touch screen input/output module;
displaying main menu options comprising:
a selection by cover option, a selection by category option, a selection by artist option, a selection by song title option, a clear all songs option, a random option, and a reject song option;
receiving a main menu selection from said main menu options;
providing a CD cover display on said touch screen input/output module when said main menu selection is said cover option;
providing a music category display on said touch screen input/output module when said main menu selection corresponds to said category option;
providing an artist display when on said touch screen input/output module when said main menu selection corresponds to said artist option;
providing a song display on said touch screen input/output module when said main menu selection corresponds to said song option;
receiving a music selection based on one of said CD cover display, said music category display, said artist display, and said song display;
playing at least one music file in a music queue, said at least one music file corresponding to said received music selection; and
clearing all songs from said music queue when said main menu selection corresponds to said clear all songs option;
playing a randomly generated music file when said main menu selection corresponds to said random option; and
playing a next music file in said music queue when said main menu selection corresponds to said reject song option.

17. The method of claim 13 further comprising:
receiving a modify data instruction; and
modifying at least one of a CD title, an artist name, and a CD music category associated with at least one music file in said music database, based on said modify data instruction.

18. The method of claim 13 wherein said touch screen input/output module is mounted on a vertical or horizontal surface.

19. The method of claim 14 wherein said touch screen input/output module is mounted in a vehicle.

20. A computer-readable medium having computer-executable instructions for performing the method of claim 16.
